(19) United States
(12) Patent Application Publication
(10) Pub. No.: US 2013/0227662 A1
(43) Pub. Date: Aug. 29, 2013

(54) Method of Generating a Token to be Used in a Uniform Resource Identifier

(71) Applicant: Shaun Crampton, San Francisco, CA (US)

(72) Inventor: Shaun Crampton, San Francisco, CA (US)

(73) Assignee: METASWITCH NETWORKS LTD., Enfield (GB)

(21) Appl. No.: 13/598,518

(22) Filed: Aug. 29, 2012

Related U.S. Application Data
(60) Provisional application No. 61/529,684, filed on Aug. 31, 2011.

(51) Int. Cl. H04L 29/06

(52) U.S. Cl. CPC H04L 63/10
USPC 726/6

(57) ABSTRACT

A method of generating a token to be used in a Uniform Resource Identifier (URI) for use in the retrieval of a data item by a user device is provided. Security setting data relating to the data item is received. A token to be used in a URI is generated. The token is associated with the data item. The token is transmitted to a user device. Generating comprises selecting a length of the token at least partly on the basis of the security setting data.

### CROSS REFERENCE TO RELATED APPLICATION

This application claims priority to U.S. Patent Application Ser. No. 61/529,684, filed on Aug. 31, 2011, the content of which is incorporated herein by reference in its entirety.

### TECHNICAL FIELD

The present invention relates to a method of generating a token to be used in a Uniform Resource Identifier (URI) for use in the retrieval of a data item by a user device. A data item service transmits the data item to a user device in response to receiving a request based upon the generated URI from the user device.

### BACKGROUND

Methods are known for retrieving a data item from a server to a user device. An example of such a method includes the use of the HyperText Transfer Protocol (HTTP) by the user device to request a desired data item from the server.

An example of data item retrieval using HTTP is as follows. An HTTP server program running on a server receives, via a communications network, an HTTP GET request containing a Uniform Resource Locator (URL) from an HTTP client program running on a user device. If a pre-existing association exists between the received URL and a data item (e.g. if the URL corresponds to a file that can be accessed by the HTTP server program), the HTTP server program will retrieve the data file and transmit it to the HTTP client program.

A URL that is transmitted to an HTTP server program in this way may have first been communicated to a user (or to a user device used by a user) in one or more of a number of ways. The URL may for example be communicated to the user in a document such as a HyperText Markup Language (HTML) document, or in an email, or a Short Messaging Services (SMS) or Multimedia Messaging Services (MMS) message, or may be written down (e.g. on paper, in an image) and read by the user, or the user may hear the URL (spoken by another person, on the radio, TV etc.)

In some cases (typically when the URL is not received electronically), in order to instruct an HTTP client program to access the data item associated with a URL the user may have to enter the URL (using a keyboard or keypad etc.) into the HTTP client program. In these cases the longer the URL, the greater the chance there is of the user making a mistake when entering it, and it also takes longer for the user to enter the URL.

In other cases (typically when a URL is received electronically, e.g. in a document or email), in order to instruct an HTTP client program to access the data item associated with a URL the user may be able to select a displayed URL (e.g. when the URL is displayed in a document). However in these cases URLs can occasionally become corrupted before being selected by the user, e.g. a URL can be truncated or have characters inserted into it (e.g. by an email client used to receive an email containing the URL). Alternatively the user may sometimes need to ‘copy’ the text of a URL from one location (e.g. from one document) and ‘paste’ the URL into the HTTP client. Once again in these cases the longer the URL, the more chance it has of being corrupted, and/or the greater the chance of the user incorrectly copying and pasting the URL.

As well as the above, shorter URLs are often favoured over long URLs where only limited space or limited numbers of characters are available (e.g. in SMS or MMS messages or ‘microblogging’ services such as Twitter). Shorter URLs may also be favoured over longer URLs for purely aesthetic reasons.

Users can address some of the above issues caused by long URLs by using short URL services, such as TinyURL and Bit.ly, which allow a user to obtain a short URL that is associated with a long URL chosen by the user. The short URLs may consist of a fixed prefix, including an Internet domain name, such as http://bit.ly/ followed by a short string of characters chosen randomly, or pseudo-randomly, from a particular alphabet of characters. This character string may be referred to as a token. An example of a complete short URL is http://bit.ly/LmvF, in which the token is the character string “LmvF”. The user can then communicate the short URL generated by the short URL service to other users, who can then use the short URL to access the corresponding long URL.

When a user tries to access a short URL that he has received (e.g. from another user, etc.), a short URL service typically operates as follows. The short URL service receives, via a communications network, an HTTP GET request containing a short URL from an HTTP client program running on a user device. As the short URL service has already associated the received short URL with a long URL, the HTTP server program will retrieve the associated long URL and transmit it to the HTTP client program. The HTTP client can then access the long URL if desired. The short URL service may also transmit an HTTP redirect response to the HTTP client, which instructs the HTTP client to immediately access the long URL.

Although short URLs can be used to avoid some of the problems of long URLs noted above, they do suffer from other issues. For example, short URLs are not secure as they can be guessed: if an attacker tries to access an existing short URL that has already been associated with a long URL, the attacker will be able to gain access to the long URL by means of the short URL. Even if the long URL is relatively secure, the corresponding short URL is typically insecure and unsuitable for use in secure applications.

The present invention aims to improve on these shortcomings.

### SUMMARY

In accordance with a first aspect of the present invention, there is provided a method of generating a token to be used in a Uniform Resource Identifier (URI) for use in the retrieval of a data item by a user device, the method comprising:
receiving security setting data relating to said data item;
generating a token to be used in a URI;
associating said token with said data item; and
transmitting said token to a user device,
wherein said generating comprises selecting a length of said token at least partly on the basis of said security setting data.

In accordance with a second aspect of the present invention, there is provided a method of generating a token to be used in a Uniform Resource Locator (URI) for use in the retrieval of a data item by a user device, the method comprising:
receiving the data item and security setting data relating to said data item;
generating a token for use in a URI, wherein said generation comprises selecting a length of said token at least partly on the basis of said security setting data; and
associating said token with said data item so that requests including said token may be responded to by the transmission of said data item.

In accordance with a third aspect of the present invention, there is provided a method of generating tokens to be used in Uniform Resource Identifiers (URIs) for use in the retrieval of data items by user devices, the method comprising:
receiving first security setting data relating to a first data item;
generating a first token to be used in a URI;
associating said first token with the first data item;
receiving second security setting data relating to a second data item, said second security setting data being different to said first security setting data; and
generating a second token to be used in a URI; and
associating said second token with the second data item,
wherein said second token is selected to be of a length different to said first token, based on said first and second security setting data.

In accordance with a fourth aspect of the present invention, there is provided method of obtaining Uniform Resource Identifiers (URIs) relating to data items, the method comprising:
receiving user input relating to a first data item;
receiving user input determining a first security setting relating to the first data item;
transmitting said first data item and data indicative of the first security setting to a data item service; and
receiving a first token associated with the first data item, the first token to be included in a URI, from the data item service,
wherein said first token has a length determined at least in part by said first security setting.

In some embodiments this aspect further comprises:
receiving user input relating to a second data item;
receiving user input determining a second security setting relating to the second data item;
transmitting said second data item and data indicative of the second security setting to the data item service; and
receiving a second token associated with the second data item, the second token to be included in a URI, from the data item service,
wherein said second token is selected to be of a length different to said first token, based on said first and second security setting data.

In accordance with a fifth aspect of the present invention, there is provided a computer program product comprising a non-transitory computer-readable storage medium having computer readable instructions stored thereon, the computer-readable instructions being executable by a computerized device to cause the computerized device to perform a method of generating tokens to be used in Uniform Resource Identifiers (URIs) for use in the retrieval of data items by user devices, the method comprising:
receiving first security setting data relating to a first data item;
generating a first token to be used in a URI;
associating said first token with the first data item;
receiving second security setting data relating to a second data item, said second security setting data being different to said first security setting data; and
generating a second token to be used in a URI; and
associating said second token with the second data item,
wherein said second token is selected to be of a length different to said first token, based on said first and second security setting data.

In accordance with a sixth aspect of the invention, there is provided apparatus for obtaining Uniform Resource Identifiers (URIs) relating to data items, the apparatus comprising:
at least one processor; and
at least one memory including computer program code, the at least one memory and the computer program code being configured to, with the at least one processor, cause the apparatus at least to perform a method of obtaining Uniform Resource Identifiers (URIs) relating to data items, the method comprising:
receiving user input relating to a first data item;
receiving user input determining a first security setting relating to the first data item;
transmitting said first data item and data indicative of the first security setting to a data item service; and
receiving a first token associated with the first data item, the first token to be included in a URI, from the data item service, said first token having a length determined at least in part by said first security setting.

Further features and advantages will become apparent from the following description of preferred various embodiments, given by way of example only, which is made with reference to the accompanying drawings.

### BRIEF DESCRIPTION OF THE DRAWINGS

FIG. 1 illustrates a data item storage system, according to various embodiments.

FIG. 2 illustrates an example of a user interface, according to various embodiments.

FIG. 3 illustrates steps performed by a data item service of the data item storage system of FIG. 1, according to various embodiments.

FIG. 4 illustrates steps performed by a data item service of the data item storage system of FIG. 1, according to various embodiments.

FIG. 5 schematically illustrates exemplary components of a computing device, according to various embodiments.

### DETAILED DESCRIPTION

In a first embodiment of the present invention, there is provided a method of generating a token to be used in a Uniform Resource Identifier (URI) for use in the retrieval of a data item by a user device, the method comprising:
receiving security setting data relating to said data item;
generating a token to be used in a URI;
associating said token with said data item; and
transmitting said token to a user device,
wherein said generating comprises selecting a length of said token at least partly on the basis of said security setting data.

This first embodiment of the invention thus enables the generation of tokens of different lengths according to received security setting data. Each token may be associated with a data item. Depending on security requirements, different lengths of token may be used in order to ensure that a particular level of security is obtained that corresponds to the given security setting data.

For example, longer tokens may be generated when more secure security setting data is received. Longer tokens may be more secure as they are harder to ‘guess’ than shorter tokens.

In some embodiments, the above method further comprises transmitting the token to a user device in response to receipt of said data item.

This allows the generated token to be sent back to a user device from which the data item was received. The generated token can then be communicated to other users once received at the user device.

Additionally or alternatively this allows the generated token to be sent to a user device different to the one from which the data item was received. In this way the generated token can be directly communicated to other users, without necessarily being first sent back to the user device.

In some embodiments the method further comprises receiving a request from a user device, the request including said token, and responding to said request by identifying said data item on the basis of the association between said data item and said token, and by transmitting said data item to said requesting user device.

In this way the data item associated with the token can be transmitted back to a user device in response to a request from that device that includes the generated token.

In some embodiments the method further comprises transmitting a URI comprising said token to a user device. For example the tokens generated may be included in a URI that is a Uniform Resource Locator (URL), i.e. with a domain name part and a slash character followed by a token in the form of a string of characters, for example they may be of the form http://eg.com/a1b2c3.

In another example the tokens generated may be included in a URI that is a SIP identifier e.g. dfl4jf023k09@short.co, where dfl4jf023k09 is the token in the URI.

In some embodiments the security setting data includes an indication of an expiry setting, wherein said selection of the length of said token is done at least partly on the basis of said indicated expiry setting. The expiry setting may relate to a length of time for which the token is to remain valid.

In some embodiments the security setting data includes an indication of a security level associated with said data item, and wherein said selection of length of said token is done at least partly on the basis of said indicated security level. The security level may for example be one of a plurality of security options such as “public”, “low security, “medium security”, “high security” etc.

In some embodiments both the data item and the security setting data may be received from a user device. This could be the same device for both the data item and the security setting data

In some embodiments the data item comprises a URI.

For example the data item may be a URL, e.g. a ‘long’ URL, for example http://www.example.com/(some long character string), for which a user wishes to generate a short URI. The token may be included in a short URI that may thus be associated with the long URL.

In another example the data item may be a file, e.g. a media file, document, email, webpage, data file, etc. for which a user wishes to generate a short URL. The token may be included in a short URI that may thus be associated with the file.

For example the data item may be a URI, e.g. a ‘long’ Session Initiation Protocol (SIP) identifier such as 6505550123@sometelecomco.com, for which a user wishes to generate a short SIP identifier. The token may be included in a short URI, e.g. another, shorter SIP identifier that may thus be associated with the long SIP identifier.

In some embodiments the method comprises receiving from a user device a plurality of requests, each respective request including a token that is not associated with a data item, and controlling how such requests are responded to, on the basis of detecting said plurality of requests.

This may include changing the rate at which such requests are responded to in order to actively prevent or limit the systematic testing of tokens by an attacker attempting to gain access to data items. In some embodiments this may include the use of rate limiting and/or intrusion detection software, as is later described in further detail.

In a second embodiment of the present invention, there is provided a method of generating a token to be used in a Uniform Resource Locator (URI) for use in the retrieval of a data item by a user device, the method comprising:
receiving the data item and security setting data relating to said data item;
generating a token for use in a URI, wherein said generation comprises selecting a length of said token at least partly on the basis of said security setting data; and
associating said token with said data item so that requests including said token may be responded to by the transmission of said data item.

In this way a token may be generated by one device and associated with the received data item. Another device may later retrieve the data item (e.g. from central storage) on the basis of the generated token.

In a third embodiment of the present invention, there is provided a method of generating tokens to be used in Uniform Resource Identifiers (URIs) for use in the retrieval of data items by user devices, the method comprising:
receiving first security setting data relating to a first data item;
generating a first token to be used in a URI;
associating said first token with the first data item;
receiving second security setting data relating to a second data item, said second security setting data being different to said first security setting data; and
generating a second token to be used in a URI; and
associating said second token with the second data item,
wherein said second token is selected to be of a length different to said first token, based on said first and second security setting data.

Thus the third embodiment enables the generation of tokens of different lengths, according to the received first and second security settings. Tokens of different lengths may be provided so that the data items may be accessible according to the security settings provided, e.g. some data items may be stored securely by using longer tokens than for other data items.

In a fourth embodiment of the present invention, there is provided method of obtaining Uniform Resource Identifiers (URIs) relating to data items, the method comprising:
receiving user input relating to a first data item;
receiving user input determining a first security setting relating to the first data item;
transmitting said first data item and data indicative of the first security setting to a data item service; and
receiving a first token associated with the first data item, the first token to be included in a URI, from the data item service,
wherein said first token has a length determined at least in part by said first security setting.

Thus the fourth embodiment enables the provision of a user interface that allows a user to enter a data item and request that a URI comprising a first token be generated for that data item. The user interface may for example be provided by a software application and/or in the form of a web page. Such a user interface may allow the user to enter a first security setting.

In some embodiments the fourth embodiment further comprises:
receiving user input relating to a second data item;
receiving user input determining a second security setting relating to the second data item;
transmitting said second data item and data indicative of the second security setting to the data item service; and
receiving a second token associated with the second data item, the second token to be included in a URI, from the data item service,
wherein said second token is selected to be of a length different to said first token, based on said first and second security setting data.

This enables the provision of a user interface that allows a user to enter a second data item and request that a URI comprising a second token be generated for the second data item. The second token may be of different length to the first, according to the first and second security settings entered by the user.

This also enables a user to obtain tokens of different lengths, according to the first and second security settings. Tokens of different lengths may be provided so that the transmitted data items may be accessible according to the security settings provided, e.g. some data items may be stored securely by using longer tokens than for other data items.

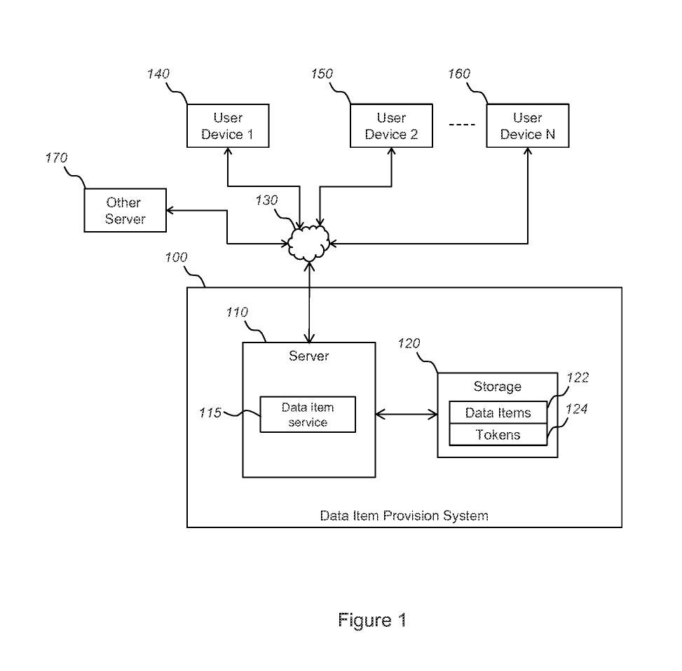

FIG. 1 illustrates a data item provision system 100, according to various embodiments. The data item provision system 100 includes a server 110 connected to a storage device 120. The server 110 is connected to a communications network 130, for example the Internet. A plurality of user devices 140-160 may communicate with the server 110 via the communications network 130.

Each user device 140-160 may have a corresponding user who uses that user device to access data items held at the server 110 and/or at other servers, e.g. 170.

Additionally the server 110 includes a data item service 115 that is configured to generate Uniform Resource Identifiers (URIs) containing unique tokens and associate these with data items sent to the data item service 115 by the user devices 140-160. These tokens may be permanent and unique at all times, or may be temporally limited with an associated expiry date or date/time, and at least unique before the expiry date or date/time. An expired token may be re-used at a later time, and associated with a different data item. A re-use delay period may be set to determine how long the data item service 115 should wait before re-using an expired token.

A user device may request a particular data item from a server (110 or 170) by transmitting a request to the server that includes a token that is associated with that data item. The server (110 or 170) is configured to respond to each request for a data item transmitted by a user device 140-160 by transmitting to the user device the data item corresponding to the token included in the received request.

Various embodiments will now be described. In various embodiments the tokens generated by the data item service 115 of the server 110 may be included in a URI that is a Uniform Resource Locator (URL), i.e. with a domain name part and a slash character followed by a token in the form of a string of characters, for example they may be of the form http://eg.com/a1b2c3. Additionally, the tokens generated by the data item service 115 may be associated with data items that are provided by users (e.g. via the user devices 140-160). Each data item may be a ‘long’ URL, for example http://www.example.com(some long character string), for which a user wishes to generate a short URL.

Each user device 140-160 may include an HTTP client which is configured to use URLs to retrieve data items from servers 110, 170 by communicating with those servers via the HTTP protocol, as described above. In this case the data item service 115 of the server 110 is an HTTP server program which is configured to receive and respond to the HTTP requests made by the HTTP clients by transmitting the requested data items to the HTTP client.

Each user device 140-160 may also transmit HTTP requests to the data item service 115 requesting that new URLs for given data items be generated. The data item service 115 may provide one or more web pages that can be accessed by the user devices 140-160 via HTTP and that form a user interface via which a user of a user device can enter a data item for which a URL is required to be generated.

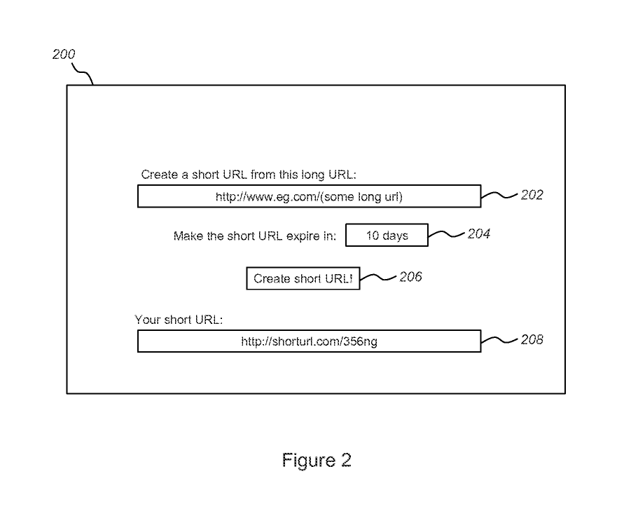

FIG. 2 illustrates an example of a user interface 200 that a user may use to request that a new URL for a data item be generated. This user interface may be provided to the users of the user devices 140-160, e.g. using web pages provided via HTTP by the data item service 115 of the server 110. The user interface 200 includes an area 202 for entering a data item (e.g. long URL) and an area 204 for entering security setting data relating to the data item. This security setting data, described in greater detail below, includes in this case an indication of an expiry setting to be applied for the URL that is to be generated for the data item entered by the user in area 202. The expiry setting may be selected from a plurality of different options, or may be entered by the user specifying a preferred period of time (e.g. number of days), in each case indicating a period of time that the generated URL should remain live. The user interface also includes a button 206 (or link, etc.) which the user may click on to transmit the request for a new URL to be generated. The URL that is generated is then displayed in the user interface 200 in area 208.

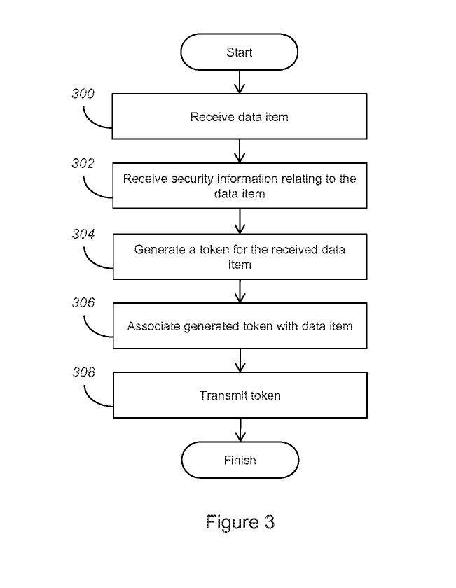

FIG. 3 illustrates the steps performed by the data item service 115 of the server 110 in order to generate a URL for a data item in response to a request for generating a new data item, as is now described.

Initially the data item service 115 of the server 110 receives a data item from a user device, e.g. 140 (step 300). The data item is received via the communications network 130, and is included in a request for a URL to be generated that is received from the user device 140 by the data item service 115. The request for a URL may for example be in the form of an HTTP POST request that includes the data item in the message body of the POST request. Alternatively, instead of an HTTP POST request an HTTP GET request could be used with the data item included in the GET request URL.

The data item service 115 also receives security setting data relating to the data item (step 302). In this embodiment, security setting data is received in the request for a URL to be generated that is received from the user device 130 by the data item service 115 (e.g. in the HTTP POST or HTTP GET request), i.e. the security setting data is received from the user device that transmits the data item for which a new URL is requested to be generated.

The security setting data that is received relates to security requirements for the URL that is to be generated for the given data item by the data item service 115. In this embodiment, the security setting data is an indication of an expiry setting for the URL that is to be generated for the given data item. The data item service 115 will thus generate a URL for the given data item that will remain valid until the indicated expiry setting has passed, as is described in further detail below.

The data item service 115 then generates a URL containing a token for the data item that was received (step 304). The token is generated on the basis of the security setting data received by the data item service 115, as is described in further detail below.

As stated above, in this embodiment the generated token is included in a URL. The URL may consist of a sequence of characters, and may include a fixed prefix, including a domain name part, such as http://eg.com/, followed by a token in the form of a unique sequence of characters generated by the data item service 115.

The unique tokens generated by the data item service 115 for the given data item may be selected randomly, or pseudo-randomly, from the set of unique sequences of characters. A token is also generated on the basis of the security setting data received by the data item service 115, as stated above.

In particular, the length of the unique sequence of characters (that form the token) is selected by the data item service 115 on the basis of the security setting data. In this embodiment, the length of the unique sequence of characters increases in correspondence with a validity period (i.e. amount of time remaining until the expiry setting (indicated in the security setting data)) increases.

By increasing the length of the tokens as the amount of time remaining until the expiry setting increases, this embodiment decreases the risk that a token can be guessed by an attacker before the token expires.

If a token is to be valid for only a short duration (i.e. small amount of time remaining until the expiry setting), then an attacker will have less time to try to guess the token, and so a shorter unique sequence of characters can be used in the token. Using a shorter unique sequence of characters means that the token formed will be shorter, and thus has a benefit associated with shorter URLs described above.

In contrast, if a token is to be valid for a long duration (i.e. large amount of time remaining until the expiry setting), then an attacker will have more time to try to guess the token, and so a longer unique sequence of characters is used in the token. Using a longer unique sequence of characters will reduce the risk that the token can be guessed by an attacker before the token expires.

The length of the unique sequence of characters that the data item service 115 uses for a given data item can be calculated using a variety of techniques. In this embodiment, the number of tokens of a particular length that are valid at any one time is significantly smaller than the set of all tokens of that particular length that could be generated by the data item service 115. In some embodiments, the proportion of valid tokens to invalid tokens is less than 1%. In some embodiments, the proportion of valid tokens to invalid tokens is less than 0.01%.

An attacker may attempt to compromise the data item provision system 100 by attempting to access large numbers of URLs, each including a different token. The attacker may attempt to access URLs including all tokens in a certain range, for example all URLs in the range http://eg.com/aaaaa, http://eg.com/aaaab, . . . http://eg.com/zzzz. The attacker may use a user device, or plurality of user devices, that he has programmed to attempt to access the tokens in the attacked range, and may attempt to access tokens at a particular rate (e.g. 100 tokens per second).

Given the above, the probability of a successful attack (i.e. the probability of an attacker guessing any existing token before that token expires) is modelled using equation (1) below.

$$P ( Successful Attack ) = 1 - {( 1 - \frac{{ct}_{l}}{{N}_{l}} )}^{{gt}_{a}} \qquad ( 1 )$$

In this equation:
c is an estimate of the average rate at which tokens of length/characters are generated by the data item service 115;
tₗ is the length of time for which tokens comprising unique sequences of length l are to be valid;
Nₗ is the total number of tokens comprising unique sequences of length l that could be generated by the data item service 115;
g is an estimate of the number of guesses an attacker makes per second during an attack and
tₐ is the estimated duration of the attack.

The data item service 115 may be configured to select the length of each unique token that is generated so that the probability of a successful attack is equal to or less than a particular value, e.g. P(Successful Attack)≦0.01. Given P(Successful Attack) and values for the variables c, tₗ, g and tₐ, the number of tokens of length l in the set of all tokens that could be generated by the data item service 115, i.e. Nₗ, can be estimated. If an alphabet of α different characters is used to generate a unique sequence of characters of length l, then l can be determined using the equation:

Nₗ=α^{l}

If for example, c=10 new tokens/second, tₗ=30 days, g=1000 guesses/second and tₐ=365 days, P(Successful Attack)=0.01 and α=32 different characters, then l=11. Thus a unique sequence of characters comprising l=11 characters should be used in the generated token.

Given the number of characters l to be used in the unique token for the new URL, the data item service 115 will, in this embodiment, select a unique sequence of characters containing that number of characters. This may be done by randomly, or pseudo-randomly, selecting l characters from the alphabet of characters to be used for the sequence, and placing the selected characters in a sequence. The data item service 115 will then check that the token is not currently in use (i.e. has not already been associated with a data item) or is not currently within the re-use delay period. If such a token already exists, the data item service 115 will generate new sequences of characters until a new, unique token is generated.

The generated token is then associated with the data item (step 306). Subsequent requests for the data item corresponding to the generated token will thus be serviced by the data item service 115 by providing the data item associated with the token, as is discussed in greater detail below. The generated token, data item, and the association between the two may be stored by the data item service 115 in storage device 120 for subsequent retrieval.

Finally, in response to the request for a URL to be generated for the data item received in step 300, the data item service 115 transmits the generated URL to the user device 140 from which the data item was received (step 308). The URL may be transmitted in a web page to the user device 140, which may then be displayed to the user of that user device. This web page may be transmitted as an HTTP response to the HTTP GET or POST request made when requesting that a URL for the data item be generated (i.e. in step 300). Once the user has received the new URL, he/she can then communicate the URL to other users who he/she wishes to access the data item.

Once a token has been generated and associated with a data item, requests for the corresponding URL can be serviced by the data item service 115. These requests may be in the form of HTTP requests received from one or more user devices. These user devices may include user devices different to the one which requested that the URL be created.

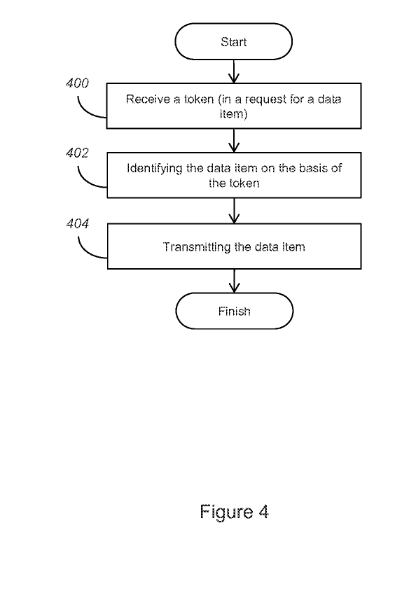

FIG. 4 illustrates the steps performed by the data item service 115 of the server 110 in order to respond to a request for the data item corresponding to a given token, as is now described.

Initially the data item service 115 of the server 110 receives a token from a user device, e.g. 150 (step 400). The token, which in this embodiment is included in a URL, may have been entered into an HTTP client program running on the user device 150 by a user of that user device. The user may have received the URL from another user via one of various means of communicating URLs as described above.

The token is received via the communications network 130, and is included in an HTTP GET or POST request that is received from the user device 150 by the data item service 115.

In response to receiving the token, the data item service 115 will use the association between the received token and its corresponding data item to identify that data item (step 402). The data item service 115 may retrieve the association from storage device 120 on the basis of the received token, and may thus identify the data item and retrieve it from storage device 120.

The data item service 115 may then transmit the data item corresponding to the token to the user device 150, in response to the request for the data item corresponding to the received token (step 404). The data item may be transmitted in an HTTP response to the HTTP GET or POST request.

It should be noted that if a request is made where no association has been made between the given token and any data item, the data item service 115 may respond with a response indicating that no data item was found, e.g. using an HTTP NOT FOUND response.

Embodiments described above thus provides a system that is able to select the length of a unique sequence of characters in a URL according to security setting data received by the data item service 115. Depending on security requirements, different lengths of token may be used in order to ensure that a particular level of security is obtained that corresponds to the given security setting data, which in this example indicates an expiry setting for the URL.

The above embodiments are to be understood as illustrative examples of the invention. Further embodiments are envisaged, as are now described.

In a first further embodiment, the data item may not be a long URL, as in embodiments described above, but may instead be a file. The file may be a media file, document, email, webpage, data file, etc. The file may be uploaded to the data item service 115 using a user interface provided by the data item service 115, such as the webpage user interface 200 for entering a data item as described above. Thus the first further embodiment allows for a user to share a data item that is a file with other users, by uploading the data file to the data item service 115, receiving a URL, generated as described above, that is then associated with the uploaded data item, and then communicating the URL to other users so that they may use it to access the data file.

In a second further embodiment, the URL, generated as described above, may be transmitted to a user device different to the user device that sent the data item to the data item service 115 (i.e. different to the user device making the request for a new URL to be generated in step 300). In this embodiment, the data item and a recipient user identifier are received by the data item service 115 in step 300. Both the data item and the recipient user identifier may be received from the user device e.g. 140 of the user requesting that a URL be created. The recipient user identifier identifies a user to which the URL generated for the given data item is to be transmitted. The recipient user identifier could be an email address, telephone number, Session Initiation Protocol (SIP) identifier and/or an identifier that identifies an account on a social networking site such as Twitter, Facebook, etc. to which the generated URL should be transmitted.

In the second further embodiment, when the URL is transmitted in step 308, it is transmitted to a user device on the basis of the recipient user identifier. For example, the generated URL may be transmitted in an email to the specified email address, in a text message (e.g. a Short Message Service (SMS) message) or voice message to the specified telephone number, or posted on or sent to the identified account on Twitter, Facebook, etc.

Thus in the second further embodiment the data item service 115 enables a user to share a data item with other users by transmitting the data item to the data item service 115, and by providing a recipient user identifier that is used by the data item service 115 to transmit the generated URL to a user device.

Additionally the user device used by the user to transmit the data item (which could be a URL or a file, e.g. media file, etc.) and the recipient user identifier could be configured to provide a user interface that allows a user to select a data item to be transmitted, and contact details (e.g. email address, telephone number, web page, blog, social network account, etc.) that will be used as the recipient user identifier. Once the user has selected a data item and a recipient user identifier, the user's user device may transmit these to the data item service 115, where a new URL for the data item may be generated and transmitted to the recipient identified by the recipient user identifier. The recipient may then access the data item using the URL provided by entering or selecting the URL on a user device, e.g. according to the steps of FIG. 4 described above. The recipient may use the same user device to receive the URL transmitted by the data item service 115 in step 308 and to then access the URL (by transmitting it back to the data item service 115) in step 404.

In an alternative arrangement of the second further embodiment, a plurality of user identifiers may be received by the data item service 115, and the URL may be transmitted to a plurality of user devices on the basis of the plurality of user identifiers in step 308.

In another alternative arrangement of the second further embodiment, as well as transmitting the URL to a user device identified by the recipient user identifier, the data item service may also transmit the URL to the user device that sent the data item to the data item service 115, as in step 308 described above.

In a third further embodiment, rather than generating the token by randomly, or pseudo-randomly, selecting a unique sequence of characters in step 304, the data item service 115 may instead generate encrypted data by encrypting the data item using a key, selecting a character string from at least part of the encrypted data, and then using this selected character string to form the token that is included in the URL. As an example, the data item may be encrypted to create encrypted data that is N characters long. From these N characters, l characters (i.e. the desired number of characters to be used in the unique sequence of characters) are selected as characters to form the token that in is included in the URL.

In an alternative to the third further embodiment, hashed data may be generated using a hash function applied to the whole or a selected part of the data item, and the character string may be selected from the hashed data.

In the above-described embodiments, a security setting is applied in the form of an expiry setting. Other types of security setting may also be used. In a fourth further embodiment, the security setting data received by the data item service 115 (on the basis of which the length l of a token is selected) may include one or more settings relating to a number of attempts that may be made to guess a valid token. This could include information indicating an estimate of the number of guesses an attacker makes per second during an attack (i.e. information indicating variable g in equation (1) above), and/or the estimated duration of such an attack (i.e. information indicating variable tₐ in equation (1) above).

In a fifth further embodiment, the security setting data received by the data item service 115 (on the basis of which the number of characters l in the unique sequence of characters in the URL is selected) may include one or more settings relating to the desired maximum probability of an attack on the token generated by the data item service 115 being successful. The user thus can thus, for example, set P(Successful Attack) (as referred to in equation (1) above), in order to control the token length.

In an alternative to the fifth further embodiment, the one or more settings relating to the desired maximum probability of a successful attack could be provided in the form of one of a plurality of security options, such as “public”, “low security, “medium security”, “high security” etc. The indication of the selection of the “public” security option could for example be interpreted by the data item service 115 as equivalent to P(Successful Attack)=1, whilst the indication of the selection of the “high” security option could for example be interpreted by the data item service 115 as equivalent to P(Successful Attack)=0.001, etc., and the length of token controlled accordingly, with the length of the generated token increasing upwards from the “public” setting to the “high security” setting.

Thus by allowing the number of characters l in the unique sequence of characters that form a token to be controlled on the basis of security setting data relating to an indication of the desired probability of a successful attack, this embodiment can allow shorter URLs to be used, e.g. when a URL relates to a data item that the user considers of low security e.g. “public”, and longer URLs to be used, e.g. when a URL relates to a data item that the user considers of high security.

In an alternative to the fourth further and fifth further embodiments, the indication of the expiry setting that is included in the security setting data in embodiments described above may also be included in the security setting data received by the data item service 115. In such embodiments, each of the different security settings may be processed in combination to determine a desired token length. For example, a token to be generated with a particular security level setting and a relatively short validity period will have a length which is shorter than that of a token to be generated with the same security level setting and a relatively long validity period. Alternatively, a default value could instead be used for the validity period by the data item service 115, or the data item service 115 may allow tokens to be valid indefinitely.

In an alternative to the fourth further and/or fifth further embodiments, the user interface provided by the data item service 115 may include areas for entering the security setting data described in the fourth further and/or fifth further embodiments.

At least some of the security setting data may not be received with the data item in the request for a new URL to be generated, but may instead be received from elsewhere. For example, at least some of the security setting data may be received from a control user device within the data item provision system 100, and/or at least some of the security setting data may be received from storage, e.g. 120, and/or at least some of the security setting data may be received in configuration information, and/or at least some of the security setting data may be pre-configured.

In an alternative to any preceding embodiment the security setting data that is received by the data item service 115 may be used in order to create URLs for a plurality of data items. For example, security setting data may be received that indicates the expiry setting of some or all data items.

In a sixth further embodiment, the data item service 115 and/or server 110 may be configured to actively prevent or limit the systematic testing of URLs by an attacker attempting to gain access to data items. For example, if the data item service 115 receives from a user device a plurality of requests for the data items corresponding to URLs, where each respective request includes a URL that is not associated with a data item, the data item service 115 may be configured to detect that these requests are being made on behalf of an attacker attempting to systematically test URLs in order to gain access to data items. The data item service may then block responses to such requests, on the basis of detecting the plurality of requests.

In order to limit the systematic testing of URLs by the attacker, the data item service 115 may change the rate at which it responds to requests made by the user device sending the said plurality of requests. For example, rather than responding to all of the requests, the data item service 115 may only respond to a proportion of the requests. The rate at which the data item service 115 selects to respond to the requests may for example be selected on the basis of the rate at which the plurality of requests are made, for example if more than x requests are made within a time t, the rate at which the data item service 115 selects to respond to the requests may be calculated as a function of variables x and/or t.

The use of rate limiting in the sixth further embodiment may mean that the estimate of the number of guesses an attacker makes per second during an attack (i.e. information indicating variable g in equation (1) above), and/or the estimated duration of such an attack (i.e. information indicating variable tₐ in equation (1) above) may be modified (e.g. either by the user, or on an automatic basis by the data item service 115) in order to better model the probability of a successful attack as shown in equation (1) above. The modified values of these variables may allow the length l of the tokens generated to be correspondingly reduced, due to the additional security provided by a decreased rate and/or duration of potential attack.

In an alternative to any embodiment, the data item service 115 and/or server 110 may be configured to use intrusion detection software to detect the systematic testing of tokens by an attacker attempting to gain access to a data item. If the intrusion detection software detects that requests consist of an attack it may change the rate at which the data item service 115 responds to the user device sending those requests, as in the sixth further embodiment. As in the sixth further embodiment, the use of rate limiting may mean that the estimate of the number of guesses an attacker makes per second during an attack, and/or the estimated duration of such an attack may be modified, allowing the length l of the tokens generated to be reduced.

In an alternative to any embodiment the data item service 115 may provide an API via which requests for new tokens and or data items corresponding to existing tokens may be received, i.e. via which the functionality of any of the above embodiments may be activated. This API may be used by programs running on the server 110 and/or by programs running remotely e.g. on user devices 140-160.

A user interface that is provided on a user device e.g. device 140 in order to allow a user to enter a data item and request that a URI be generated for that data item, may be provided by a software application, rather than in the form of a web page. Such a user interface may allow the user to enter security setting data and a recipient user identifier etc., as described above.

It will be appreciated that a user interface may be provided to a user via a user device to enable the generation of tokens to be used in Uniform Resource Locators (URLs) for use in the retrieval of data items by user devices. The user interface may do this by operating as is now described.

Firstly, the user interface receives first security setting data relating to a first data item.

The user interface then generates a first token to be used in a URL and associates the first token with the first data item. This may be done by the user interface receiving user input relating to the first data item, receiving user input determining a first security setting relating to the first data item, transmitting the first data item and data indicative of the first security setting to a data item service (e.g. data item service 112), and receiving a first token associated with the first data item, the first token to be included in a URL, from the data item service 115. As described in the above embodiments, the first token will thus have a length determined at least in part by the first security setting.

The user interface then receives second security setting data relating to a second data item. This second security setting data is different to the first security setting data.

The user interface then generates a second token to be used in a URL and associates the second token with the second data item. As described the second token will be selected to be of a length different to the first token, based on the first and second security setting data. This may be done by the user interface receiving user input relating to the second data item, receiving user input determining a second security setting relating to the second data item, transmitting the second data item and data indicative of the second security setting to a data item service (e.g. data item service 112), and receiving a second token associated with the second data item, the second token to be included in a URL, from the data item service 115. As described in the above embodiments, the second token will thus have a length determined at least in part by the second security setting.

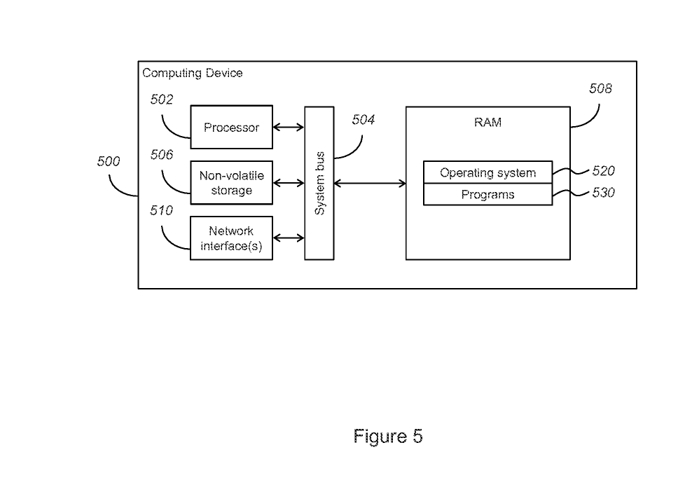

The server 110 and user devices 140-160 may each be a computing device such as a mobile phone, smartphone, a personal digital assistant (PDA), a computer, etc., though in preferred embodiments the server 110 is a computer. FIG. 5 schematically illustrates exemplary components of a computing device 500.

The computing device 500 includes a processor 502 and components connected to a system bus 504, where these components may include a non-volatile storage device 506, random access memory 508, and network interface 510. The computing device may also include a user input interface and a graphics processing component that is connected to a display.

The processor 502 may be configured to execute computer instructions for one or more computer programs including an operating system 520 and other programs 530. For the server 110 these other programs 530 may include the data item service 115 described above. For user devices 140-160 these other programs 530 may include an HTTP client program.

The network interface 510 (or plurality of such interfaces) of the computing device 500 allows programs running on the processor 502 of the computing device 500 to transmit and receive data to and from a number of other devices and systems via a communications network (or a plurality of such networks), e.g. communications network 130.

The network interface 510 (or the plurality of such interfaces) may include a radio access network interface (or a plurality of such interfaces) that is able to communicate with a wireless access node such as a base station or a wireless access point that provides access to a communications network (e.g. 130) or a plurality of such networks. The network interface 510 (or plurality of such interfaces) may be able to connect to the wireless access node using one or more of a number of radio access technologies including Global System for Mobile Communications (GSM), Universal Mobile Telecommunications System (UMTS), Long Term Evolution (LTE), fixed wireless access (such as IEEE 802.16 (“WiMax”)), and wireless networking (such as IEEE 802.11 (“WiFi”)). The communications network (e.g. 130) and/or wireless access node may also provide access to the Internet. The network interface 510 (or the plurality of such interfaces) may also include a modem and/or an Ethernet card or interface for use with a corresponding communications network (e.g. 130), or networks, such as the Internet and/or a private data communications network.

In an alternative to any embodiment, the data item service 115 may be distributed over a plurality of servers. The security setting data may be received on one server via an Application Programming Interface (API) call from another server, or from a user device.

The storage device 120 may be located within the server 110 or within any other server e.g. of the data item provision system 100. Alternatively the storage device 120 may be distributed over a plurality of servers.

The storage device 120 may include a database within which data items 122, tokens 124 and associations between them are stored. The data item service 115 may be configured to query this database in order to retrieve data items on the basis of tokens with which they have been associated.

It should be noted that the data item service 115 need not transmit a full URI to a user device—in the alternative, if for example the user device includes a URI generating application, the data item service may generate only the token, and transmit the token to the user device, on which a full URI is then generated, containing the received token.

In an alternative to any of the embodiments described above, the data item service 115 may be configured to generate URIs which are not URLs. Any protocol where a type of URI is used and where one or more devices have the ability to re-direct or forward requests relating to that type of URI could benefit from the use of the data item service 115.

For example, the data item service 115 may be configured to generate URIs that are Session Initiation Protocol (SIP) identifiers, each of which includes a unique token associated with a data item stored by the data item service 115. In Voice over Internet Protocol (VoIP) communications sessions, for example, SIP identifiers may be used in order to identify one or more of the parties that are to be involved in a VoIP communications session.

A first user that is setting up a VoIP communications session may for example enter a SIP identifier into a first device in order to identify a second user with which to establish the communications session. The first device then communicates with one or more devices in order to establish a communications session with the user identified by the given SIP identifier. In order to establish the communications session another device such as a proxy server, registrar or redirect server may receive the SIP identifier and either redirect the communications session on the basis of the SIP identifier (e.g. redirect the communications session to another SIP identifier), or return a network identifier (e.g. Internet Protocol (IP) address etc), so that the communications session can be established with the second user.

The data item service 115 could be used in this context as follows. The second user may enter his SIP identifier, e.g. 6505550123@sometelecomco.com, as a data item into the data item service 115, along with security setting data, in order to obtain a URI comprising a token from the data item service 115. The URI obtained may for example be dfl4jf023k09@short.co, where dfl4jf023k09 is the token in the URI. The token in the URI may be associated with the data item entered by the second user, i.e. with the second user's SIP identifier.

The second user may then communicate the URI obtained from the data item service 115 to the first user, e.g. in an email or otherwise. Now, when the user sets up a VoIP communications session with the second user, he uses the URI received from the second user. In this case, in order to establish the communications session another device such as a proxy server, registrar or redirect server may receive the URI and may redirect the communications session, on the basis of the URI, to the second user's SIP identifier.

In order to redirect the communications session to the second user's SIP identifier, this other device may first communicate with the data item service 115 in order to retrieve the second user's SIP identifier, i.e. the device may transmit the SIP identifier to the data item service 115, the data item service 115 thus receives a token (in the SIP identifier) from the other device (i.e. step 400 of FIG. 4), identifies the data item associated with that token (i.e. the second user's SIP identifier) and transmits the data item to the other device.

The data item service 115 may thus be used in order to provide, for example, ‘disposable’ SIP identifiers. A ‘disposable’ first SIP identifier in the form of a URI comprising a token may be generated by the data item service 115 and associated with a second SIP identifier, where the second SIP identifier is provided to the data item service 115 by a user who wishes to hide this second SIP identifier from one or more other users. The user could revoke a ‘disposable’ SIP identifier that he obtains in this way in order to prevent further communications sessions made using that SIP identifier to be redirected to him.

In an alternative to any of the embodiments described above, the data item service 115 may not check, in step 304, if a generated token is not already in use, as for tokens comprising more than a certain number of characters the probability of this occurring may be very low. Instead the data item service 115 could instead overwrite the existing association with an existing data item with a new association with the new data item in step 306.

In an alternative to any of the embodiments described above, the tokens generated by the data item service 115 of the server 110 may be included in Uniform Resource Locators (URLs) or other types of URIs such that the token is included as a prefix to a string of other characters such as a domain name, e.g. 23474.domain.com. In another alternative the token may be preceded or followed by a prefix or suffix that is a string of other characters that may for example denote a file type or category of the token, e.g. http://eg.com/a1b2c3.jpg or http://eg.com/news/a1b2c3.

In an alternative to any of the embodiments described above, different means for transmitting data items, URIs, requests for new URIs to be generated and/or requests for data items corresponding to given URLs may be used. For example, rather than using the HTTP protocol, alternative communications protocols could be used. In another example, one or more of the above could be transmitted in an email, text message, or any other format that could be received and processed by the data item service 115.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of generating a token to be used in a Uniform Resource Identifier (URI) for use in the retrieval of a data item by a user device, comprising:
receiving security setting data relating to said data item;
generating a token to be used in a URI;
associating said token with said data item; and
transmitting said token to a user device,
wherein said generating comprises selecting a length of said token at least partly on the basis of said security setting data.

2. The method according to claim 1, further comprising transmitting said token to a user device in response to receipt of said data item.

3. The method according to claim 1, further comprising:
receiving a request from a user device, the request including said token; and
responding to said request by identifying said data item on the basis of the association between said data item and said token, and by transmitting said data item to said requesting user device.

4. The method according to claim 1, wherein said security setting data includes an indication of an expiry setting, wherein said selection of the length of said token is done at least partly on the basis of said indicated expiry setting.

5. The method according to claim 1, wherein said security setting data includes an indication of a security level associated with said data item, and wherein said selection of length of said token is done at least partly on the basis of said indicated security level.

6. The method according to claim 1, further comprising transmitting a URI comprising said token to a user device.

7. The method according to claim 1, further comprising receiving said data item and said security setting data from a user device.

8. The method according to claim 1, wherein said generation comprises randomly or pseudo-randomly selecting each character in said token.

9. The method according to claims 1, wherein said generation comprises generating encrypted data by encrypting said data item using a key, and selecting said token from at least part of said encrypted data.

10. The method according to claim 1, wherein said data item comprises a URI.

11. The method according to claim 1, wherein said data item comprises a file.

12. The method according to claim 1, further comprising:
receiving from a user device a plurality of requests, each respective request including a token that is not associated with a data item; and
controlling how such requests are responded to, on the basis of detecting said plurality of requests.

13. The method according to claim 12, further comprising controlling a rate at which such requests are responded to, on the basis of detecting said plurality of requests.

14. The method according to claim 12, further comprising blocking responses to such requests, on the basis of detecting said plurality of requests.

15. The method according to claim 1, wherein a said URI comprises a URL including said token.

16. The method according to claim 1, wherein a said URI comprises a Session Initiation Protocol (SIP) identifier including said token.

17. A method of generating a token to be used in a Uniform Resource Locator (URI) for use in the retrieval of a data item by a user device, comprising:
receiving the data item and security setting data relating to said data item;
generating a token for use in a URI, wherein said generation comprises selecting a length of said token at least partly on the basis of said security setting data; and
associating said token with said data item so that requests including said token may be responded to by the transmission of said data item.

18. A method of generating tokens to be used in Uniform Resource Identifiers (URIs) for use in the retrieval of data items by user devices, comprising:
receiving first security setting data relating to a first data item;
generating a first token to be used in a URI;
associating said first token with the first data item;
receiving second security setting data relating to a second data item, said second security setting data being different to said first security setting data;
generating a second token to be used in a URI; and
associating said second token with the second data item,
wherein said second token is selected to be of a length different to said first token, based on said first and second security setting data.

19. A method of obtaining Uniform Resource Identifiers (URIs) relating to data items, comprising:
receiving user input relating to a first data item;
receiving user input determining a first security setting relating to the first data item;
transmitting said first data item and data indicative of the first security setting to a data item service; and
receiving a first token associated with the first data item, the first token to be included in a URI, from the data item service,
wherein said first token has a length determined at least in part by said first security setting.

20. The method according to claim 19, further comprising:
receiving user input relating to a second data item;
receiving user input determining a second security setting relating to the second data item;
transmitting said second data item and data indicative of the second security setting to the data item service; and
receiving a second token associated with the second data item, the second token to be included in a URI, from the data item service,
wherein said second token is selected to be of a length different to said first token, based on said first and second security setting data.

21. A computer program product comprising a non-transitory computer-readable storage medium having computer readable instructions stored thereon, the computer-readable instructions being executable by a computerized device to cause the computerized device to perform a method of generating tokens to be used in Uniform Resource Identifiers (URIs) for use in the retrieval of data items by user devices, the method comprising:
receiving first security setting data relating to a first data item;
generating a first token to be used in a URI;
associating said first token with the first data item;
receiving second security setting data relating to a second data item, said second security setting data being different to said first security setting data;
generating a second token to be used in a URI; and
associating said second token with the second data item,
wherein said second token is selected to be of a length different to said first token, based on said first and second security setting data.

22. An apparatus for obtaining Uniform Resource Identifiers (URIs) relating to data items, the apparatus comprising:
at least one processor; and
at least one memory including computer program code;
wherein the memory and the computer program code are configured to cause the processor to perform a method of obtaining Uniform Resource Identifiers (URIs) relating to data items, the method comprising:
receiving user input relating to a first data item,
receiving user input determining a first security setting relating to the first data item,
transmitting said first data item and data indicative of the first security setting to a data item service, and
receiving a first token associated with the first data item, the first token to be included in a URI, from the data item service, said first token having a length determined at least in part by said first security setting.
